(19) United States
(12) Patent Application Publication
(10) Pub. No.: US 2020/0074228 A1
(43) Pub. Date: Mar. 5, 2020

(54) RGBD SENSING BASED OBJECT DETECTION SYSTEM AND METHOD THEREOF

(71) Applicant: Robert Bosch GmbH, Stuttgart (DE)

(72) Inventors: Jonathan Francis, Pittsburgh, PA (US); Sirajum Munir, Pittsburgh, PA (US); Charles Shelton, Monroeville, PA (US)

(21) Appl. No.: 16/468,164

(22) PCT Filed: Dec. 12, 2017
(86) PCT No.: PCT/EP2017/082301

§ 371 Date: Jun. 10, 2019

Related U.S. Application Data
(60) Provisional application No. 62/438,215, filed on Dec. 22, 2016.

(51) Int. Cl. G06K 9/62; G06T 7/254; G06T 11/60; G06K 9/00

(52) U.S. Cl. CPC G06K 9/6256; G06T 7/254; G06T 11/60; G06K 2209/21; G06T 2207/10024; G06T 2207/10028; G06T 2207/20224; G06K 9/00671

(57) ABSTRACT

An RGBD sensing based system for detecting, tracking, classifying, and reporting objects in real-time includes a processor, a computer readable media, and a communication interface communicatively coupled to each other via a system bus is illustrated. An object detection module is integrated into the system that detects and tracks any objects that are moved under its field of view.

### FIELD

This disclosure relates generally to sensing systems and, more particularly, to a Red Green Blue Depth (RGBD) sensing and object detection system and method thereof.

### BACKGROUND

Unless otherwise indicated herein, the materials described in this section are not prior art to the claims in this application and are not admitted to the prior art by inclusion in this section.

Cameras have been widely used for surveillance purposes. However, such cameras lack the ability to automatically detect objects that people bring into buildings and carry with them and occupant profile identification. As a result, existing camera based systems are incapable to control Heating, Ventilation, and Air Conditioning (HVAC) units efficiently using this information. Also, existing camera based systems cannot detect objects like guns automatically to alert the occupants and security personnels.

### BRIEF DESCRIPTION OF THE DRAWINGS

These and other features, aspects, and advantages of this disclosure will become better understood when the following detailed description of certain exemplary embodiments is read with reference to the accompanying drawings in which like characters represent like arts throughout the drawings, wherein:

FIG. 1A illustrates a detection network architecture according to an exemplary embodiment of the disclosure;

FIG. 1B illustrates a RGBD sensing based system installed above an entryway as an example according to a described embodiment of the disclosure;

FIG. 1C illustrates a block diagram of the RGBD sensing based system of FIG. 1B according to an example of the disclosure;

FIGS. 2A-2D illustrate various schematic diagrams of a person carrying different objects such as a laptop, a backpack, a box, or a cell phone using a RGBD sensing based system;

FIGS. 3A-3C illustrate various schematic diagrams of a sample background subtraction process for RGB images.

FIGS. 4A-4C illustrate various schematic diagrams of a sample background subtraction process for depth images.

FIGS. 5A and 5B illustrate various schematic diagrams of a location of an object determined in the annotation step.

### DETAILED DESCRIPTION

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

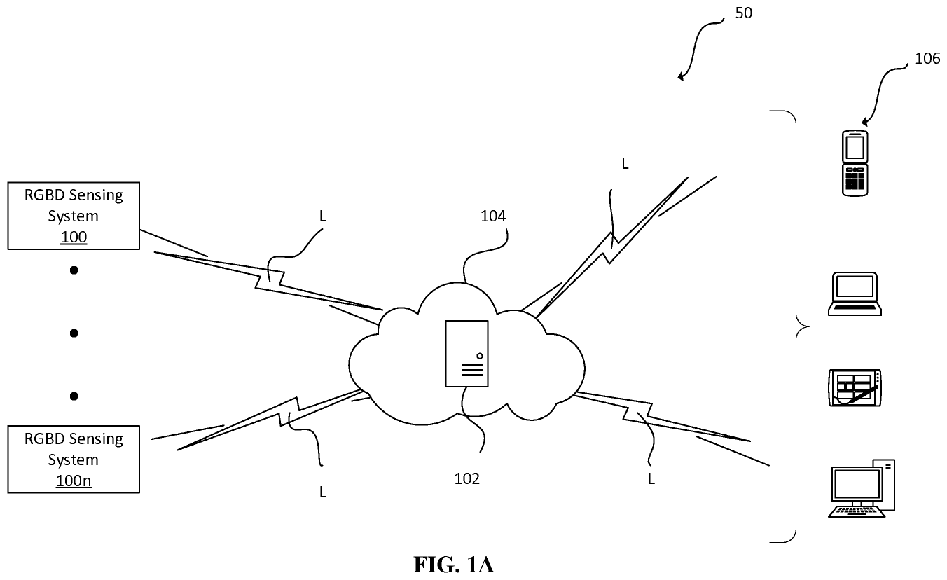

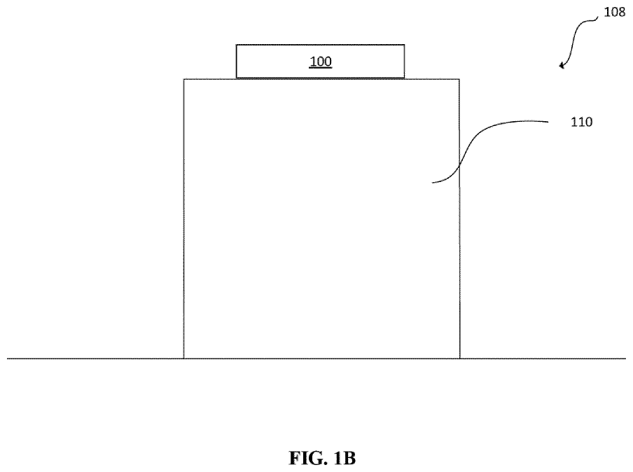

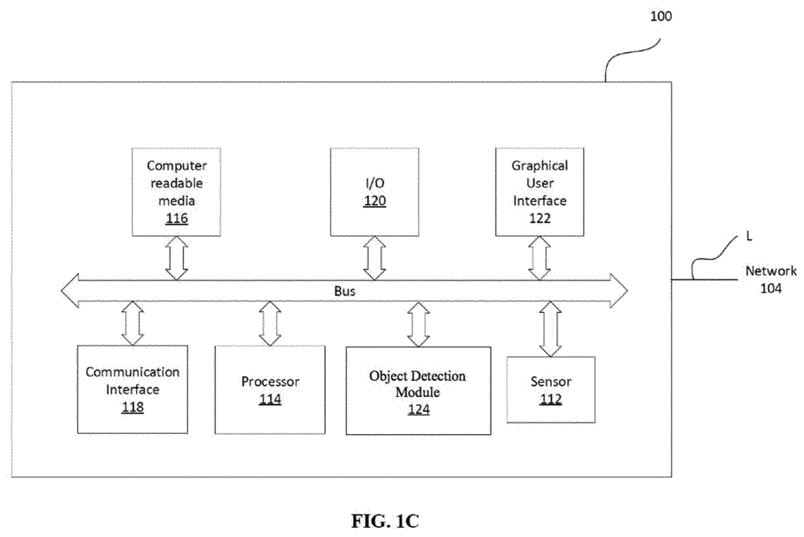

FIG. 1A illustrates a detection network architecture 50 according to an exemplary embodiment of the disclosure. The detection network architecture 50 includes a RGBD sensing based system, a plurality of RGBD sensing based system 100, 100n is illustrated, communicatively coupled to a server 102 over a network 104 via a communication link L. The RGBD sensing based system 100, 100n includes a RGBD sensing element such as a camera, a sensor, or any suitable sensing elements that are capable to detect parameter such as depth or distance and transmit or output the detected parameter to at least one of a computer implemented module located within the RGBD sensing based system or a machine 106. The server 102 may be an application server, a certificate server, a mobile information server, an e-commerce server, a FTP server, a directory server, CMS server, a printer server, a management server, a mail server, a public/private access server, a real-time communication server, a database server, a proxy server, a streaming media server, or the like. The network 104 can comprise one or more sub-networks and the server 102 within the network system 100. The network 104 can be for example a local-area network (LAN), a metropolitan area network (MAN), a wide area network (WAN), a primary public network with a private sub-network, a primary private network with a public sub-network, a primary private network with a private sub-network 104, a cloud network, or any suitable networks. Still further embodiments, the network 104 that can be any network types such as a point to point network, a broadcast network, a telecommunication network, a data communication network, a computer network, an ATM (Asynchronous Transfer Mode) network, a SONET (Synchronous Optical Network) network, a SDH (Synchronous Digital Hierarchy) network, a wireless network, a wireline network, and the like. Depending on the application, other networks may be used so that data exchanged between the client machine and the server can be transmitted over the network. Network topology of the network 104 can differ within different embodiments which may include a. bus network topology, a star network topology, a ring network topology, a repeater-based network topology, or a tiered-star network topology. Additional embodiments may include a network of mobile telephone networks that use a protocol to communicate among mobile devices, where the protocol can be for example AMPS, TDMA, CDMA, GSM, GPRS, UMTS, LTE or any other protocol able to transmit data among mobile devices. Although more than one RGBD sensing based system 100, 100n is provided in a site in same location, only one RGBD sensing based system 100 may be installed in each site either in the same location or different locations. If there are more than one site in various locations, at least one RGBD sensing based system 100 may be installed in each site per location. A plurality of RGBD sensing based system 100, 100n may be installed and connected to one or multiple sub-networks, defined as a primary network, located between the RGBD sensing based systems and the server 102. The site may be a premise, a room, a place, a space regardless open or closed, any commonplaces, any private access places or locations, and the like. The RGBD sensing based system 100 is configured to detect occupants, objects carried by the occupants or brought into a site or a location in real-time. In some embodiments, the RGBD sensing based system 100 may be configured to identify profile of the occupants, the objects, or combination thereof in real-time. In other embodiment, the RGBD sensing based system 100 may be configured to track or monitor number of occupants leaving and/or entering the site, incoming and outgoing objects, or combination thereof in real-time. In further embodiment, the RGBD sensing based system 100 may be configured to control an environment within the site or the location with respect to a detected event including occupancy, objects, or combination thereof.

The communication link L may be wired, wireless, or combination thereof. The detection network architecture 50 may be used in commonplace such as offices, enterprise-wide computer networks, intranets, internets, public computer networks, or combination thereof. The wireless communication link may include cellular protocol, data packet protocol, radio frequency protocol, satellite band, infrared channel, or any other protocol able to transmit data among client machines. The wired communication link may include any wired line link. At least one machine 106 is communicatively coupled to the RGBD sensing based system 100, 100n via the least one of the network 104 or the server 102. The machine 106 may be a personal computer or desktop computer, a laptop, a cellular or smart phone, a tablet, a personal digital assistant (PDA), a wearable device, a gaming console, an audio device, a video device, an entertainment device such as a television, a vehicle infotainment, or any suitable devices. In some embodiments, the machine 106 may be a HVAC unit, a lighting unit, a security unit, or any suitable machines.

FIG. 1B illustrates an RGBD sensing based detection system 100 installed on a site 108. The site 108 includes an entryway 110 and the RGBD sensing based detection system 100 is mounted above the entryway 110 configured to at least detect occupants, objects carried by the occupants or brought into a site or a location, identify profile of the occupants, the objects, or combination thereof, track or monitor number of occupants leaving and/or entering the site, incoming and outgoing objects, or control an environment within the site or the location with respect to a detected event including occupancy, objects, or combination thereof, in real time. For simplicity, the door is omitted from the figure. The site 108 may be a room, a place, a space regardless in an open or closed site, any commonplaces, any private access places or locations, and the like. The RGBD sensing based detection system 100 is communicatively coupled to one or more of the server, network, client machine, and the RGBD sensing based detection system 100 via either a wireless or wired communication link. The RGBD sensing based detection system 100 is powered by any suitable energy source. Although the RGBD sensing based detection system 100 is illustrated as a single device, the RGBD sensing based detection system 100 may be integrated into other devices such as a security system, a HVAC unit, a lighting unit, an entryway control system, or any suitable devices.

FIG. 1C illustrates a block diagram of the RGBD sensing based detection system 100 of FIG. 1B. The system 100 includes a sensing element such as a sensor 112, a processor 114, a computer readable medium 116, a communication interface 118, an input/output subsystem 120, and a graphical user interface (GUI) 122. Depending on the application, other computer implemented devices or modules for performing features or functionality not defined herein may be incorporated into the system 100. One or more system buses 220 coupled to one or more computer implemented devices 112, 114, 116, 118, 120, 122 for facilitating communication between various computer implemented devices 112, 114, 116, 118, 120, 122, one or more output devices, one or more peripheral interfaces, and one or more communication devices is provided. The system buses 220 may be any types of bus structures including a memory or a memory controller, a peripheral bus, a local bus, and any type of bus architectures. The sensor 112 may be an RGBD sensor, a RGBD camera, a RGBD imaging device, or any suitable sensing element capable to detect parameter such as depth or distance. Although one sensor 112 is illustrated, more than one RGBD sensor may be integrated into the system 100. Other types of sensor such as optical sensors, imaging sensors, acoustic sensors, motion sensors, global positioning system sensors, thermal sensors, environmental sensors, and so forth may be coupled to the depth sensor and mounted within the system 100. In some embodiments, other non-depth sensor as a separate device may be electrically coupled to the system 100. The processor 114 may be a general or special purpose microprocessor operating under control of computer executable instructions, such as program modules, being executed by a client machine 106. Program modules generally include routines, programs, objects, components, data structure and the like that perform particular tasks or implement particular abstract types. The processor 114 may be a microprocessor (μP), a microcontroller (μC), a digital signal processor (DSP), or any combination thereof. The processor 114 may include one or more levels of caching, such as a level cache memory, one or more processor cores, and registers. The example processor cores 114 may (each) include an arithmetic logic unit (ALU), a floating point unit (FPU), a digital signal processing core (DSP Core), or any combination thereof. In one embodiment, some or all of the sub-processors may be implemented as computer software tangibly stored in a memory to perform their respective functions when executed. In alternate embodiment, some or all of the sub-processors may be implemented in an ASIC. As illustrated, the processor 114 is a low power microprocessor configured to process RGBD data. The computer readable media 116 may be partitioned or otherwise mapped to reflect the boundaries of the various subcomponents. The computer readable media 116 typically includes both volatile and non-volatile media, removable and non-removable media. For example, the computer readable media 116 includes computer storage media and communication media. Computer storage media includes both volatile and nonvolatile, removable and non-removable media implemented in any method or technology, CD-ROM, DVD, optical disk storage, magnetic cassettes, magnetic tape, magnetic disk storage or other magnetic storage device, or any other medium which can be used to store the desired information and which can accessed by a client machine. For example, computer storage media can include a combination of random access memory (RAM), read only memory (ROM) such as BIOS. Communication media typically includes computer readable instructions, data structures, program modules, or other data in a modulated data signal such a carrier wave or other transport mechanism and include any information delivery media. Communication media may also include wired media such as a wired network or direct-wired communication, and wireless media such as acoustic, RF, infrared (IR) and other wireless media. Communications of the any of the above should also be included with the scope of computer readable media.

The input/output subsystem 120 includes various end user interfaces such as a display, a keyboard, joystick, a mouse, a trackball, a touch pad, a touch screen or tablet input, a foot control, a servo control, a game pad input, an infrared or laser pointer, a camera-based gestured input, and the like capable of controlling different aspects of the machine operation. For example, user can input information by typing, touching a screen, saying a sentence, recording a video, or other similar inputs. The communication interface 118 allows software and data to be transferred between the computer system and other external electronic devices in the form of data or signals which may be, for example, electronic, electromagnetic, optical, or other signals capable of being received by the communication interface 118. The communication interface 118 may be for example a modem, a network interface, a communication port, a PCM-CIA slot and card, or the like.

The system further includes an object detection module 124 communicatively coupled to one or more computer implemented devices 112, 114, 116, 118, 120, 122 via the system buses 220. In another embodiment, the module 124 may be embedded into the processor 114 and is configured to at least detect occupants, objects carried by the occupants or brought into a site or a location or identify profile of the occupants, the objects, or combination thereof on the site in real-time as described in further detail below. In some embodiments, the sensor 112 may be integrated into the object detection module 124. In another embodiment, a tracking module may be provided track or monitor number of occupants leaving and/or entering the site, incoming and outgoing objects. In one example, the processor 114 is configured to process the sensed data from the sensor 112 or the detected data from the module 124 and transmit the processed data for control the condition of an environment within the site or the location with respect to the processed data. The sensed data including occupancy, objects, or combination thereof in real time. The condition of an environment such as the heating and cooling conditions, lighting condition, any normal and abnormal activities can be controlled by at least one of a HVAC unit, a lighting unit, a security unit, or any suitable units/devices via the processor 114. In another embodiment, one or more of the processors 114 is integrated into at least one of a HVAC unit, a lighting unit, a security unit, or any suitable units/devices. The data sensed by the sensor 112 or detected by the module 124 is transmitted to the processor 114 located in at least one of a HVAC unit, a lighting unit, a security unit, or any suitable units/devices via a communication interface 118 for processing.

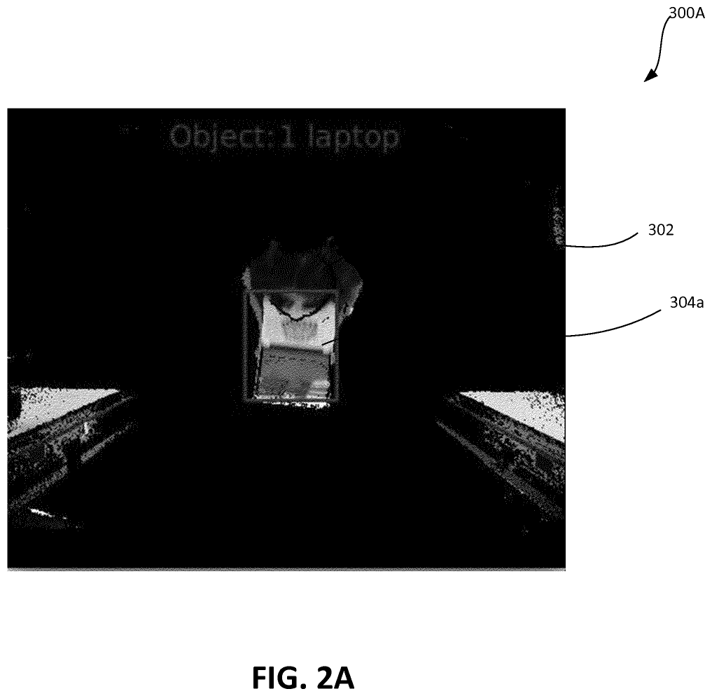

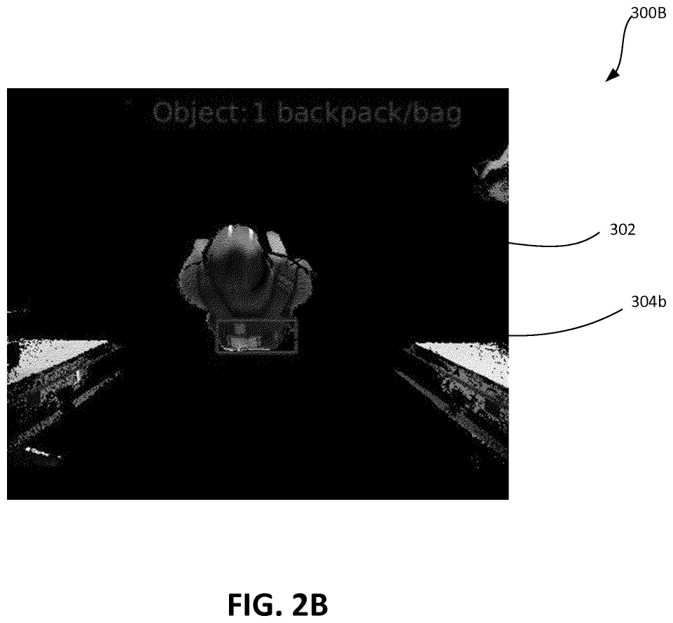

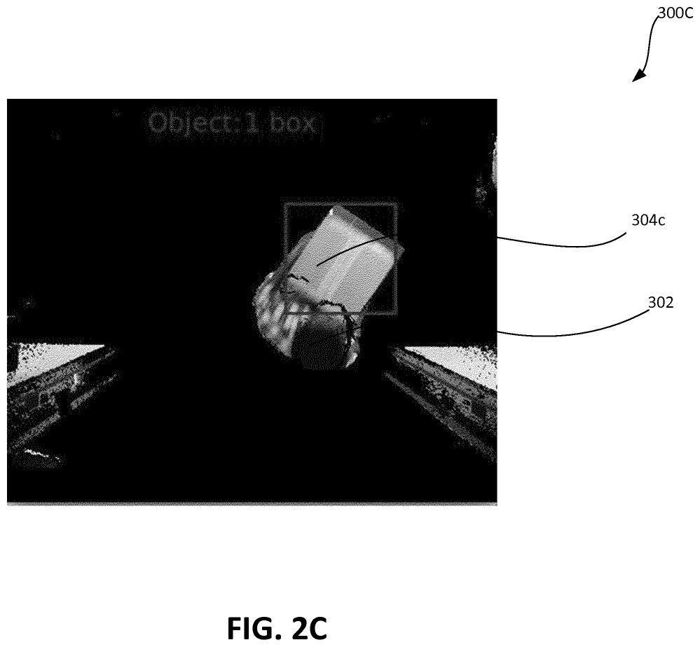

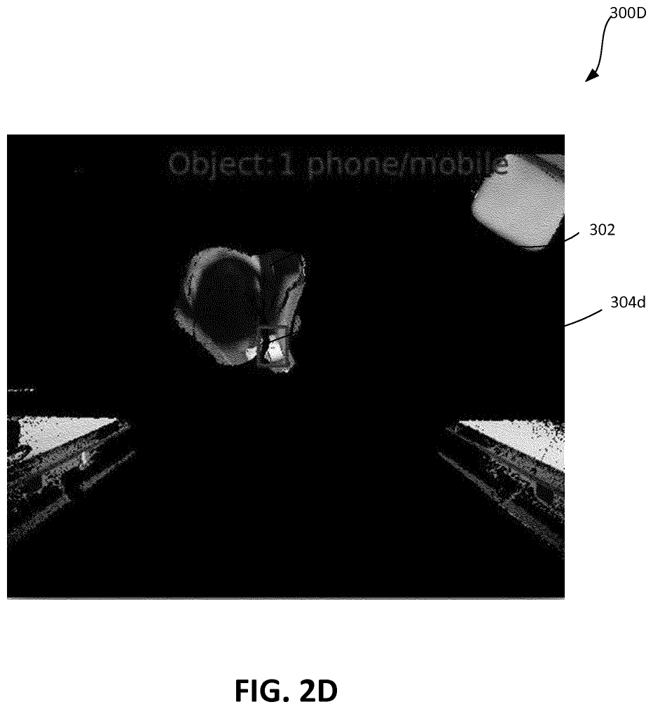

FIGS. 2A-2D illustrate various schematic diagrams 300 of a person 302 carrying different objects such as a laptop 304a, a backpack 304b, a box 304c, or a mobile device such as a cellphone 304d using a RGBD sensing based system 100 mounted above the person 302. Depending on the application, any objects other than the objects illustrated may be detected. The object detection module 124 of the RGBD sensing based system 100 receives various RGBD images as input from the sensor 112. The RGBD images taken from top view as depicted in FIGS. 2A-2D may be two-dimensional images, three-dimension images, or higher dimensional images. In one embodiment, an image analysis module either coupled to at least one of the object detection module 124 or the processor 114, or integrated into at least one of the object detection module or the processor 114, is configured to classify image elements of the RGBD image into background image and other images including human and objects, and subtract the background image from the RGBD image.

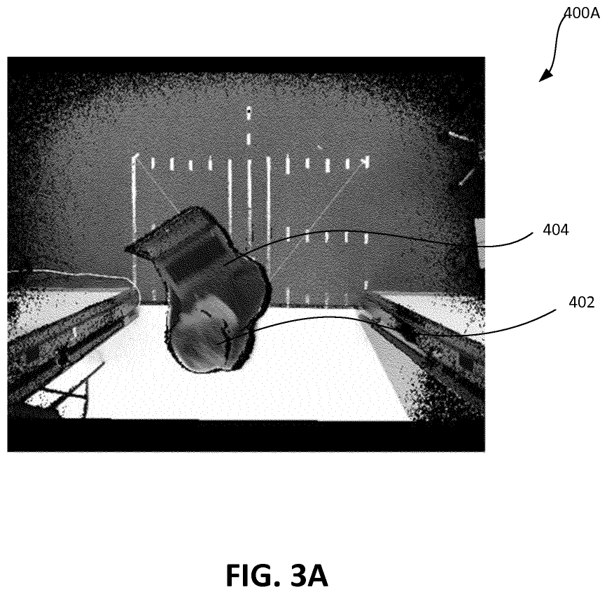

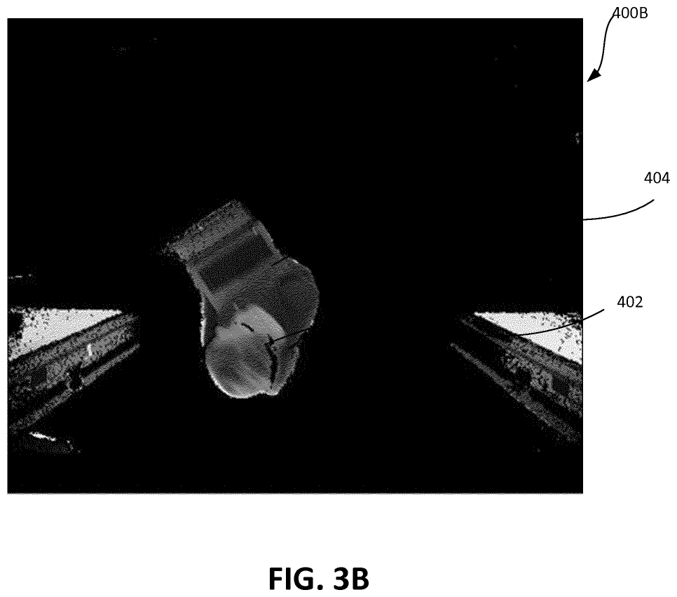

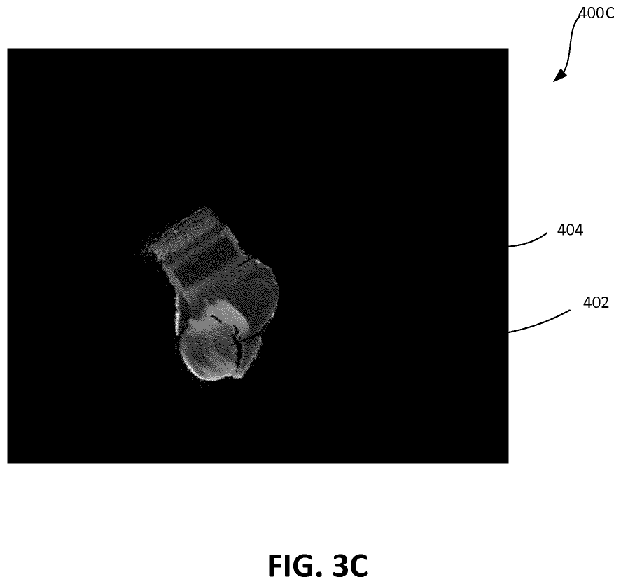

Now referring to FIGS. 3A-3C, various processed images 400a-400c are illustrated. At FIG. 3A, a RGBD image 400a from a top view showing a person 402 holding a laptop 404 is taken by the RGBD sensing based detected system 100. The RGBD image 400a can be taken every time a person or an object is detected; in one embodiment. In another embodiment, the RGBD image 400a is taken using a training engine either incorporated into the object detection system 100 or coupled to the object detection system 100 during classification, subtraction, and annotation processes. For example, a background image is taken by at least one of the training engine or the object detection system when there is no one in the scene initially. The background image may include static objects such as wall, frame, window, floor, or any suitable static objects. The at least one of the objection system or the training engine takes an image 400a when someone is in the scene including the background and static objects (e.g., walls), and the person holding an object, as shown in FIG. 3A. The background image taken alone is similar to the background captured in the RGBD image 400a (without humans and object that s/he is carrying). One of the training engine or the object detection system preprocesses the image 400a by subtracting the background floor from the image. For instance, FIG. 3B illustrates the preprocessed RGBD image 400b comprises of the person 402 holding the laptop 404 when the background floor is removed. The image 400b in FIG. 3B is further processed to remove the surrounding static walls and the resulting RGB image 400c is shown in FIG. 3C

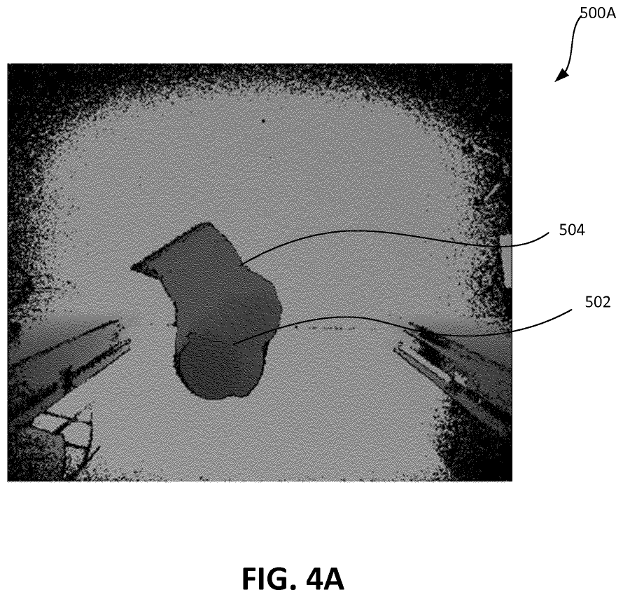

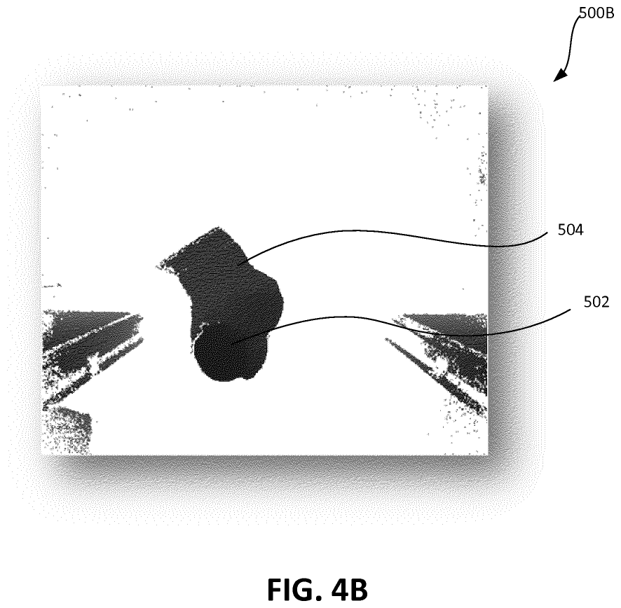

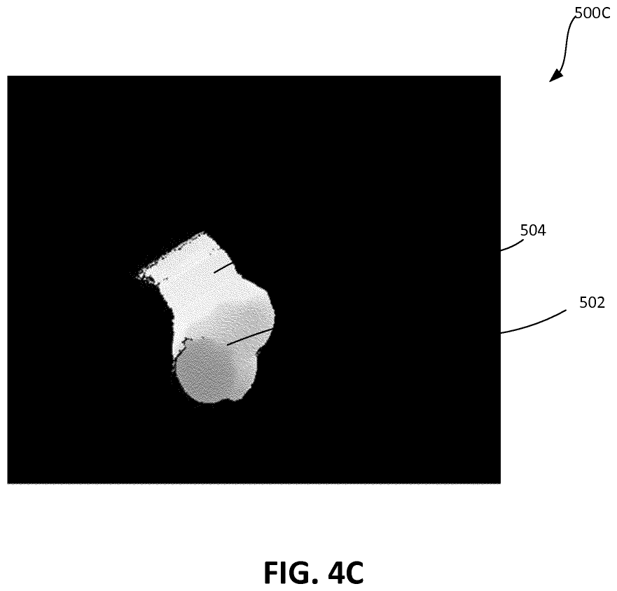

FIGS. 4A-4C illustrate various processed images 500A-500C are illustrated. The images 500A-500C are similar to images 400A-400C of FIGS. 3A-3C except that instead of using RGB camera, a depth camera is used to capture the frame. For instance, FIG. 4A illustrates a depth image 500A from a top view showing a person 502 holding a laptop 504 is taken by the RGBD sensing based detected system 100. The RGBD image 500a can be taken every time a person or an object is detected; in one embodiment. In another embodiment, the RGBD image 500a is taken using a training engine either incorporated into the object detection system 100 or coupled to the object detection system 100 during classification, subtraction, and annotation processes. For example, one of the training engine or the object detection system captures the background scene when no one is in the scene. The background image may include static objects such as wall, frame, window, floor, or any suitable static objects. The at least one of the objection system or the training engine takes an image 400A when someone is in the scene including the background and static objects (e.g., walls), and a person holding an object comes in the scene, as shown in FIG. 4B. The background image taken alone is similar to the background captured in the depth image 400A. One of the training engine or the object detection system preprocesses the image 400a by subtracting the background and static objects from the depth image 400A to obtain a clear depth image containing dynamic elements like people and objects as shown in images 400B, 400C of FIGS. 4B and 4C. After the background is subtracted, pixels that are not affected by movement becomes 0 and hence shown black in FIG. 4C.

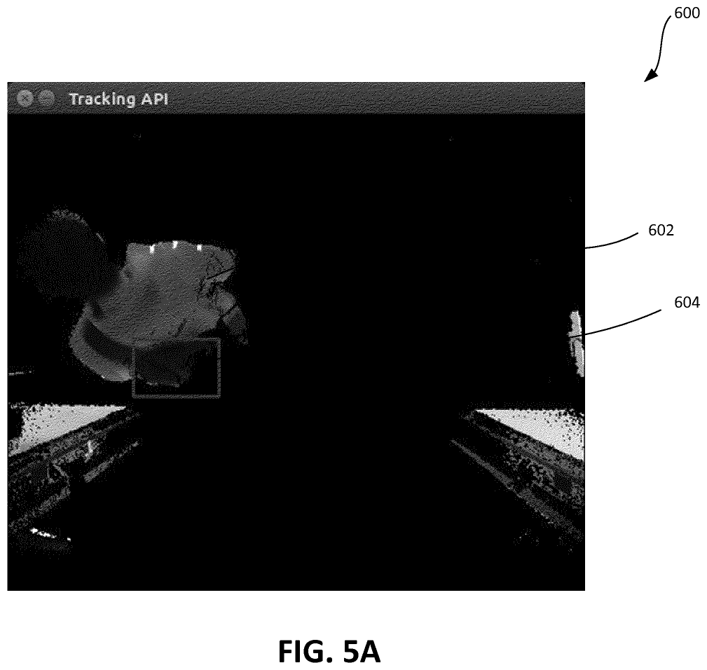

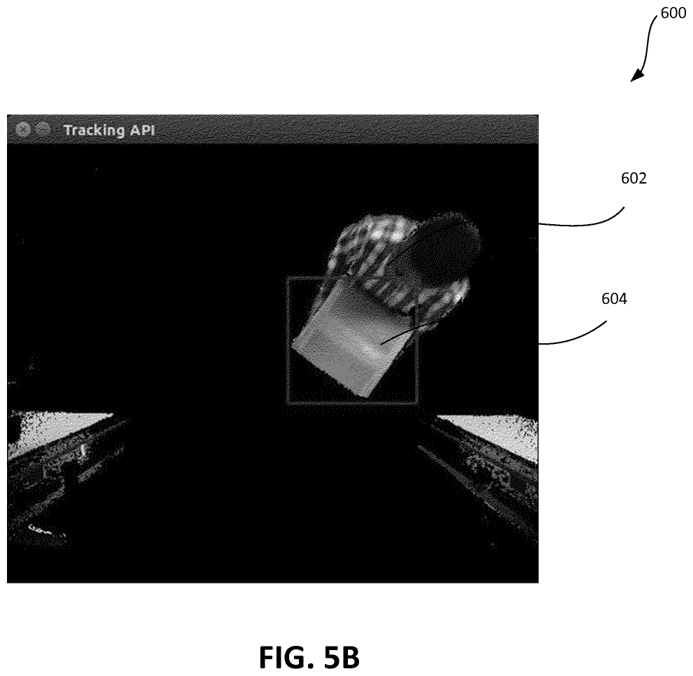

FIGS. 5A and 5B illustrate various schematic diagram 600 of one or more of an annotated element. Locations 602, 604 and any objects such as a backpack 606, a box 608 are annotated using an annotated module either integrated into at least one of the processor 114, the object detection module 124, or any suitable computer implemented module of the depth sensing based module 100. For example, FIG. 5A depicts the location of a backpack 606 and FIG. 5B depicts the location of a box 608.

In one embodiment, the RGBD sensing based system 100 comprises a training engine to perform at least one of classification, subtraction, or annotation. The training engine may be running on the object detection module 124, the processor 114, or any suitable computer implemented module. The training engine may use at least one of a neural network, a deep neural network, an artificial neural network, a convolutional neural network, or any suitable machine learning networks. In some embodiments, output by the training engine (e.g., detected objects that someone carrying, profile identification) may be used to control an environment within the site or the location. The condition of an environment such as the heating and cooling conditions, lighting condition, any normal and abnormal activities. In another embodiment, classification output may be used to control any devices including a HVAC unit, a lighting unit, a security unit, or any suitable units/devices. In yet further embodiment, the training engine may be deployed to continuous keep track and detect any events, occupancy, objects in real time. At least one of the event, occupancy, or object is transmitted, reported, and displayed.

The embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling with the sprit and scope of this disclosure.

While the patent has been described with reference to various embodiments, it will be understood that these embodiments are illustrative and that the scope of the disclosure is not limited to them. Many variations, modifications, additions, and improvements are possible. More generally, embodiments in accordance with the patent have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

1. A sensing based detection system comprising:
an object detection module configured to receive an input image, the object detection module executing a training engine, wherein the training engine is configured to:
classify elements in the input image into one or more layered images;
subtract at least one or more layered images to a processed image;
annotate one or more elements in the processed image.

2. The sensing based detection system of claim 1 further comprising a communication interface coupled to the object detection module for transmitting the processed image.

3. The sensing based detection system of claim 2 wherein the element is at least one of an event, an occupant, or an object.

4. The sensing based detection system of claim 2 wherein the processed image is used to control a condition of an environment within a site or a location.

5. The sensing based detection system of claim 4 wherein the condition of the environment is at least one of heating and cooling conditions, lighting conditions, or normal and abnormal activities.

6. The sensing based detection system of claim 2 further comprising a device coupled to the communication interface.

7. The sensing based detection system of claim 6 wherein the device is controlled by at least one of the sensing based detection system, or a processor, or a client machine.

8. The sensing based detection system of claim 7 wherein the device is a HVAC unit, a lighting unit, and a security unit.

9. The sensing based detection system of claim 7 wherein the client machine is a personal computer or desktop computer, a laptop, a cellular or smart phone, a tablet, a personal digital assistant (PDA), and a wearable device.

10. The sensing based detection system of claim 2, further comprising a camera.

11. The sensing based detection system of claim 2, further comprising a camera including a depth imaging sensor.

12. The sensing based detection system of claim 10 or 11, wherein the camera includes a RGB imaging sensor.

13. A RGBD sensing based detection system comprising:
an object detection module configured to receive an input image, the object detection module executing a training engine, wherein the training engine is configured to:
classify elements in the input image into one or more layered images;
subtract at least one or more layered images to a processed image;
annotate one or more elements in the processed image.
